(19) United States
(12) Patent Application Publication
(10) Pub. No.: US 2006/0076894 A1
(43) Pub. Date: Apr. 13, 2006

(54) Vehicle headlamp

(76) Inventors: Johannes Petrus Maria Ansems, Eindhoven (NL); Josephus Christiaan Maria Hendricx, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/536,811

(22) PCT Filed: Nov. 12, 2003
(86) PCT No.: PCT/IB03/50021

§ 371 Date: May 27, 2005

(30) Foreign Application Priority Data
Dec. 2, 2002 (EP) 02080024.9

(51) Int. Cl. H01J 1/62; H01J 63/04; H01J 17/16; H01J 61/35

(52) U.S. Cl. 313/635; 313/634; 313/573; 313/493; 313/489

(57) ABSTRACT

Vehicle headlamp provided with a metal halide lamp comprising a discharge vessel surrounded with clearance by an outer envelope and having a ceramic wall which encloses a discharge space containing xenon (Xe) and an ionizable filling, wherein in said discharge space two electrodes are arranged whose tips have a mutual interspacing EA so as to define a discharge path between them, wherein the discharge vessel has an internal diameter Di at least over the distance EA, and wherein Di is smaller than or equal to 2 mm and the relation EA/Di is smaller than 6, with the special feature that said vehicle headlamp has not more than one band-shaped light-absorbing coating laterally of the discharge path.

The present invention relates to a vehicle headlamp provided with a metal halide lamp comprising a discharge vessel surrounded with clearance by an outer envelope and having a ceramic wall which encloses a discharge space containing xenon (Xe) and an ionizable filling, wherein in said discharge space two electrodes are arranged whose tips have a mutual interspacing EA so as to define a discharge path between them, wherein the discharge vessel has an internal diameter Di at least over the distance EA, and wherein Di is smaller than or equal to 2 mm and the relation EA/Di is smaller than 6. The invention also relates to a metal halide lamp to be used in the present headlamp.

Such a lamp is known from international (PCT) patent publication no. WO 00/67294 in the name of the same Applicant. This known electric discharge lamp has a tubular, light-transmissive ceramic lamp vessel, for example of polycrystalline aluminum oxide, and a first and a second current conductor which enter the lamp vessel opposite to each other and each support an electrode in the lamp vessel, for example a tungsten electrode which is welded to the respective current conductor. The second current conductor has a return portion extending along an outside of the outer envelope made of quartz. A ceramic sealing compound provided in a melting process seals the lamp around the current conductors in a gastight manner. The lamp vessel has an ionizable filling comprising xenon as a rare gas and metal halides. The abovementioned specific dimensions of the discharge vessel of the known lamp ensure a very compact and lightweight lamp.

A disadvantage of the vehicle headlamp described in the cited international (PCT-) patent publication is the following. Particularly for obtaining a headlamp with a European passing beam, it is required to form a sufficiently sharp beam delineation in the beam pattern in order to avoid radiation of light giving rise to glare, for example. It is noted that radiation of light as such does not only refer to stray light; just below the light/dark-boundary in a beam pattern there must be a very high light intensity to illuminate a road at a large distance, whereas just above said light/dark-boundary a very low light intensity must be present to avoid glare. Obviously, such a dazzling of oncoming traffic could lead to dangerous, i.e. lifethreatening traffic situations. In this respect it is noted that ECE regulations for European passing beam headlamps are very strict.

It is an object of the present invention to provide a vehicle headlamp of the type described in the introduction of the description with which the occurrence of light resulting in glare is avoided and with which a very sharp beam delineation is obtained. To achieve this object, such a headlamp is characterized in that said headlamp has not more than one band-shaped light-absorbing coating laterally of a discharge axis of the discharge vessel.

Accordingly, either said headlamp has no band-shaped light-absorbing coating at all, or only one band-shaped light-absorbing coating is present on the outer envelope or on the outer side of the ceramic wall of the discharge vessel. In the latter case the band-shaped light-absorbing coating extends laterally of the discharge axis of the discharge vessel, i.e. more or less laterally of the discharge path. An advantage of providing the band-shaped light-absorbing coating on the outer side of the ceramic wall of the discharge vessel is that the width of said coating is much smaller than in a situation wherein the outer envelope is provided with a band-shaped light-absorbing coating. Said width is namely mainly determined by the distance between the band-shaped light-absorbing coating and a central axis of the metal halide lamp. If the band-shaped light-absorbing coating is closer to the discharge in the discharge vessel, a smaller width of said band-shaped light-absorbing coating results in a sharper beam delineation.

The present invention is based on the recognition that a rectilinear light/dark boundary is achieved with only one band-shaped light-absorbing coating at the most, as the very compact shape of the vehicle headlamp (especially the extremely small diameter of the tube and the corresponding small diameter of the outer bulb) ensures that said coating can be positioned on or very close to the discharge vessel. Accordingly, a substantially paraboloidal reflector present in the headlamp ensures that light incident thereon is not thrown to the exterior in a beam (that is: “not directed to the glare area in the beam pattern”) through the headlamp lens, but instead ensures that this light is blended with the useful light (that is: “meant for a lighted area in the beam pattern”).

In a preferred embodiment of a vehicle headlamp according to the invention, the band-shaped light-absorbing coating is provided on the inner side of the outer envelope. In an alternative embodiment, the band-shaped light-absorbing coating is provided on the outer side of the outer envelope.

In another preferred embodiment of a vehicle headlamp according to the invention, the band-shaped light-absorbing coating is located underneath a horizontal plane along the central axis of the metal halide lamp during operation, while an edge of the band-shaped light-absorbing coating directed towards said horizontal plane and the horizontal plane itself enclose an angle of substantially 15° with one another. Preferably, an edge of the band-shaped light-absorbing coating directed towards said horizontal plane and an edge of the band-shaped light-absorbing coating directed away from said horizontal plane enclose an angle of between 15° and 55° with one another. Of course, the band-shaped light-absorbing coating will have a different position for right- and left-handed traffic.

In another preferred embodiment of a vehicle headlamp according to the invention, the discharge vessel has a circumferential clearance inside the outer envelope of at most 5 mm.

In another preferred embodiment of a vehicle headlamp according to the invention, the outer envelope is conically shaped, with the band-shaped light-absorbing coating—seen from a lamp cap supported by the outer envelope—extending in outwarddirection away from the discharge vessel. This further enhances the sharpness of the beam delineation. In order to improve the sharpness of the dark/light boundary still further, the band-shaped light-absorbing coating has a profiled shape, as will be explained further below. For increasing the amount of light radiated on the reflector and thus for obtaining a smaller width of the band-shaped light-absorbing coating, a central axis of the metal halide lamp is located at a distance above an optical axis of a reflector present in the headlamp during operation, said distance varying between 0.1 and 0.9 mm, preferably being 0.5 mm, more in particular 0.45 mm.

It is noted that the present invention is not restricted to the use of mercury (Hg) as part of the ionizable filling of the metal halide lamp; a mercury-free filling may also be used in the said lamp. In the latter case the relation EA/Di will be below 8.

The above and further aspects of the headlamp in accordance with the invention will now be explained with reference to a drawing (not true to scale), in which

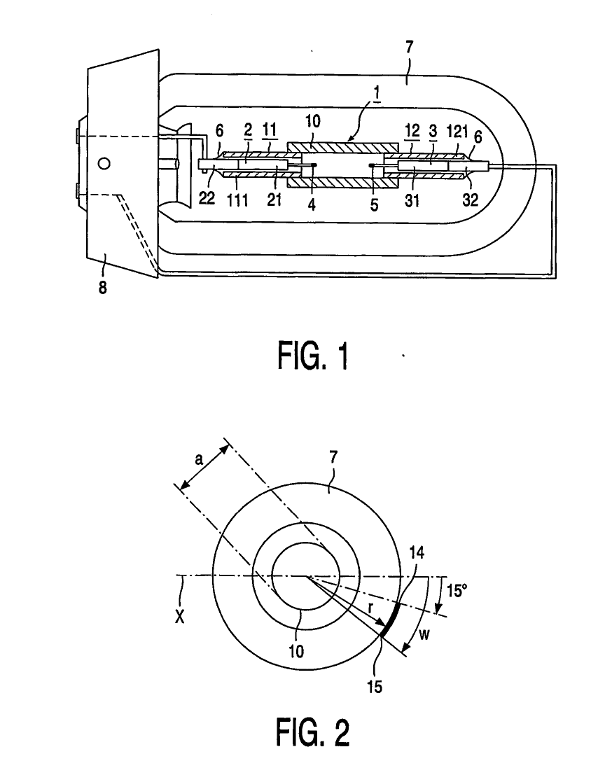

FIG. 1 shows an embodiment in a side elevation, and

FIG. 2 shows a cross-section of the embodiment of FIG. 1.

In FIG. 1, the electric discharge lamp has a tubular, light-transmissive ceramic lamp vessel, of polycrystalline aluminum oxide in the Figure, and a first and a second current conductor 2, 3 which enter the lamp vessel 1 opposite each other and each support an electrode 4,5 in the lamp vessel 1, i.e. a tungsten electrode which is welded to the respective current conductor 2,3. in the Figure. A ceramic sealing compound 6, 30% by weight of aluminum oxide, 40% by weight of silicon oxide and 30% by weight of dysprosium oxide, in the Figure, provided in a melting process, seals the lamp vessel 1 around the current conductors 2, 3 in a gastight manner. The lamp vessel has an ionizable filling comprising argon as a rare gas and metal halide. A mixture of sodium, thallium and dysprosium iodides is used as a metal halide.

The first current conductor 2 has a first halide-resistant part 21 within the lamp vessel 1 and, extending from the ceramic sealing compound 6 to the exterior of the lamp vessel, a second part 22 which is welded to the first part 21.

The first part 21 of the first current conductor 2 consists of a material chosen, for example, from tungsten silicide, molybdenum aluminide, molybdenum boride, pentamolybdenum trisilicide, and combinations of at least of two of these materials.

In the lamp shown, the second current conductor 3 has a similar first part 31 and second part 32 as the first current conductor 2. The second part 22, 32 of each of the two current conductors 2, 3 consists of niobium, the first part 21, 31 of each of the two consists of tungsten silicide, for example W₅Si₃.

The lamp vessel 1 has narrow end parts 11, 12 in which respective current conductors 2, 3 are enclosed. The end parts 11, 12 have free ends 111, 121 where the lamp vessel 1 is sealed by the ceramic sealing compound 6. The central part 10 of the lamp vessel 1 is connected to the end parts 11,12 by means of sintering.

The second part 22, 32 of each current conductor is entirely incorporated in the ceramic sealing compound 6 with the lamp vessel 1.

In FIG. 1, the lamp vessel 1 is enveloped by an outer envelope 7 which is sealed in a gastight manner and is evacuated or filled with an inert gas in order to protect the niobium second parts 22, 32 of the current conductors 2, 3. The outer envelope 7 supports a lamp cap 8. In another embodiment, the outer envelope 7 may be provided with two lamp caps, for example R7 lamp caps.

FIG. 2 shows a band-shaped light-absorbing coating 9 during operation, located underneath a horizontal plane X that extends along a central axis of the metal halide lamp. An edge 14 of the band-shaped light-absorbing coating 9 directed towards said horizontal plane X and the horizontal plane itself enclose an angle of substantially 15° with one another. Preferably, an edge 14 of the band-shaped light-absorbing coating 9 directed towards said horizontal plane X and an edge 15 of the band-shaped light-absorbing coating 9 directed away from said horizontal plane X enclose an angle of between 15° and 55° with one another. Of course, the band-shaped light-absorbing coating 9 will have a different position for right- and left-handed traffic. Said band-shaped light-absorbing coating 9 could have a profiled shape, such as corrugated, i.e. in waves.

The distance between the electrode tips EA is 5 mm, the internal diameter Di is 1.4 mm, so that the ratio EA/Di=3.57.

1. Vehicle headlamp provided with a metal halide lamp comprising a discharge vessel surrounded with clearance by an outer envelope and having a ceramic wall which encloses a discharge space containing xenon (Xe) and an ionizable filling, wherein in said discharge space two electrodes are arranged whose tips have a mutual interspacing EA so as to define a discharge path between them, wherein the discharge vessel has an internal diameter Di at least over the distance EA, and wherein Di is smaller than or equal to 2 mm and the relation EA/Di is smaller than 6, characterized in that said vehicle headlamp has not more than one band-shaped light-absorbing coating laterally of the discharge path.

2. Vehicle headlamp according to claim 1, wherein the band-shaped light-absorbing coating is provided on the outer side of the ceramic wall of the discharge vessel.

3. Vehicle headlamp according to claim 1, wherein the band-shaped light-absorbing coating is provided on the inner side of the outer envelope.

4. Vehicle headlamp according to claim 1, wherein the band-shaped light-absorbing coating is provided on the outer side of the outer envelope.

5. Vehicle headlamp according to claim 1, wherein the band-shaped light-absorbing coating is located underneath a horizontal plane along a central axis of the metal halide lamp during operation, while an edge of the band-shaped light-absorbing coating directed towards said horizontal plane and the horizontal plane itself enclose an angle of substantially 15° with one another.

6. Vehicle headlamp according to claim 5, wherein an edge of the band-shaped light-absorbing coating directed towards said horizontal plane and an edge of the band-shaped light-absorbing coating directed away from said horizontal plane enclose an angle of between 15° and 55° with one another.

7. Vehicle headlamp according to claim 1, wherein the discharge vessel has a circumferential clearance inside the outer envelope of at most 5 mm.

8. Vehicle headlamp according to claim 1, wherein the outer envelope is conically shaped and wherein the band-shaped light-absorbing coating—seen from a lamp cap supported by the outer envelope—extends in outward direction away from the discharge vessel.

9. Vehicle headlamp according to claim 1, wherein the band-shaped light-absorbing coating has a profiled shape.

10. Vehicle headlamp according to claim 1, wherein a central axis of the metal halide lamp is located at a distance above an optical axis of a reflector present in the headlamp during operation, said distance varying between 0.1 and 0.9 mm, being in particular 0.5 mm, more in particular 0.45 mm.

11. A metal halide lamp to be used in a vehicle headlamp according to claim 1.
